(19) United States
(12) Patent Application Publication
(10) Pub. No.: US 2025/0363374 A1
(43) Pub. Date: Nov. 27, 2025

(54) ARTIFICIAL INTELLIGENCE DEVICE FOR IDENTITY-BASED TEST TIME ADAPTATION (ID-TTA) AND METHOD THEREOF

(71) Applicant: LG ELECTRONICS INC., Seoul (KR)

(72) Inventors: Sen JIA, Scarborough (CA); Homa FASHANDI, Toronto (CA); Amirhossein HAJAVI, Toronto (CA)

(73) Assignee: LG ELECTRONICS INC., Seoul (KR)

(21) Appl. No.: 19/219,743

(22) Filed: May 27, 2025

Related U.S. Application Data
(60) Provisional application No. 63/651,458, filed on May 24, 2024.

(51) Int. Cl. G06N 3/0895

(52) U.S. Cl. CPC G06N 3/0895

(57) ABSTRACT

A method for controlling an artificial intelligence (AI) device can include obtaining a pre-trained AI model configured to generate embeddings from input data, receiving unlabeled target data from a target domain different than a source domain used to train the pre-trained AI model, determining first parameter updates for the pre-trained AI model by performing a self-supervised adaptation process based on a correlation between a first input sample and an augmented version of the first input sample, and generating an updated AI model based on the first parameter updates. Also, the method can further include determining second parameter updates by performing a pair-wise adaptation process based on adjusting embedding representations of a pair of input samples based on a threshold to correspond to a same identity, and generating a final adapted AI model based on the second parameter updates, the final adapted AI model being adapted to the target domain.

### CROSS-REFERENCE TO RELATED APPLICATIONS

This non-provisional application claims priority under 35 U.S.C. § 119(e) to U.S. Provisional Application No. 63/651,458, filed on May 24, 2024, the entirety of which is hereby expressly incorporated by reference into the present application.

### BACKGROUND

### Field

The present disclosure relates to a device and method for improved adaptation of an artificial intelligence (AI) model. Particularly, the method can perform IDentity-based Test-Time Adaptation (ID-TTA), which can provide enhanced recognition accuracy in previously unseen target domains and efficient classifier-free model adaptation directly in the embedding space, while operating without reliance on source data or target domain labels.

### Discussion of the Related Art

Artificial intelligence (AI) continues to transform various aspects of society and help users by powering advancements in various fields, particularly with regards to interactive applications and metric learning, which can include identification systems (e.g., face or voice recognition).

These systems often rely on pre-trained models to learn embeddings, which are numerical representations of input data (e.g., vector representations). Operations and various comparisons can be performed on these types of embeddings to generate various results (e.g., determining if two images or two voice samples belong to the same identity or same user).

However, significant challenges arise when these pre-trained models encounter new data from a target domain (e.g., a specific user's home environment or device) that differs from the source domain (e.g., the data used for initial training, such as when trained in a lab or at the time of manufacture). This “domain gap” can lead to a substantial degradation in model performance.

For example, a face recognition model trained on high-quality studio images captured by a high quality camera in ideal studio lighting conditions may perform poorly when used with images captured by a user's mobile phone camera in variable lighting conditions. Similarly, domain gap degradation can be experienced when the pre-trained model is applied to data from a new demographic or different environmental conditions whose inherent data characteristics and statistical distributions significantly diverge from those of the original training data.

Existing approaches to address this domain gap often rely on optimizing an objective function related to the output of a classifier, such as minimizing the entropy of the predicted class probabilities. These methods assume the presence of a classifier head during inference, which is used to guide the adaptation process. Unfortunately, these existing strategies suffer from various limitations, particularly in the context of identity (ID) verification or recognition systems.

In many such systems, especially those deployed on edge devices or where privacy is a concern, the final classifier used during training is discarded or not used, and only the embedding extractor is deployed. Thus, existing methods that depend on a classifier's output (e.g., for entropy minimization) are not applicable to these “classifier-free” ID systems. Furthermore, accessing the original source data or labels for the target domain data is often infeasible due to privacy, storage, or transmission constraints.

Thus, there exists a need for improved methods that can effectively adapt pre-trained models at test-time directly in the embedding space, without requiring access to the original source data, target data labels, or a classifier head. Such methods are needed to enhance the robustness and accuracy of ID systems when deployed in diverse and previously unseen target domains, thereby improving user experience and system reliability. For example, a next exists for a method that can better help AI models more effectively learn and adapt on the fly when deployed at the end user's environment (e.g., when used at the user's home).

Also, a need exists for a method that can achieve improved performance and accuracy even when operating on previously unseen target domains, while operating without reliance on the source data or target domain labels, such as the ability to adapt itself when using new unlabeled data.

### SUMMARY OF THE DISCLOSURE

The present disclosure has been made in view of the above problems and it is an object of the present disclosure to provide a device and method for improved adaptation of an artificial intelligence (AI) model. Further, the method can perform IDentity-based Test-Time Adaptation (ID-TTA) with enhanced recognition accuracy in previously unseen target domains and efficient classifier-free model adaptation directly in the embedding space, while operating without reliance on source data or target domain labels.

An object of the present disclosure is to provide an artificial intelligence (AI) device and method for test time adaptation for adapting an AI model that can address performance degradation when such models encounter new, unlabeled target domain data exhibiting domain shift. The method can distinctively adapt the model directly in its embedding space without reliance on a source-trained classifier, original source data, or target data labels, by utilizing at least one of or both of a self-supervised adaptation module that promotes representational consistency between original target samples and their identity-preserving augmented views, and a pair-wise adaptation module that refines embedding distributions based on similarity assessments of sample pairs from the target data relative to a same-identity threshold, thereby enhancing model accuracy and robustness in diverse target operational environments.

Another object of the present disclosure is to provide a method for controlling an artificial intelligence (AI) device that can include obtaining a pre-trained AI model configured to generate embeddings from input data, receiving unlabeled target data from a target domain different than a source domain used to train the pre-trained AI model, determining first parameter updates for the pre-trained AI model by performing a self-supervised adaptation process based on a correlation between a first input sample and an augmented version of the first input sample, generating an updated AI model based on the first parameter updates, determining second parameter updates by performing a pair-wise adaptation process based on adjusting embedding representations of a pair of input samples based on a threshold to correspond to a same identity, and generating a final adapted AI model based on the second parameter updates, the final adapted AI model being adapted to the target domain.

It is another object of the present disclosure to provide a method that further includes receiving a new input sample corresponding to a user and determining an identity of the user based on the final adapted AI model.

Yet another object of the present disclosure is to provide a method, in which the generating the augmented version of the first input sample include applying a transformation to the first input sample that preserves an identity of the first input sample while altering other visual or acoustic characteristics of the first input sample.

An object of the present disclosure is to provide a method, in which the transformation is randomly selected from a predefined set of transformations including at least one of a rotation, a translation, a crop, a scaling, a color jitter, a blur, an addition of noise, a change in audio speed, a change in audio pitch, and a change in audio volume.

Another object of the present disclosure is to provide a method, in which the self-supervised adaptation process includes determining the first parameter updates based on optimizing a correlation matrix computed from embeddings of a plurality of input samples including the first input sample and embeddings of corresponding augmented versions, in which the optimizing increases correlation for embeddings derived from a same input sample and a corresponding augmented version.

An object of the present disclosure is to provide a method, in which the threshold used in the pair-wise adaptation process is a dynamic threshold adjusted based on a comparison of embeddings generated by the updated AI model for the pair of input samples and embeddings generated by a frozen, non-adapted copy of the pre-trained AI model for the pair of input samples.

Yet another object of the present disclosure is to provide a method, in which the adjusting embedding representations of the pair of input samples to correspond to a same identity is based on minimizing a distance metric between embeddings of the pair of input samples when the pair of input samples is determined to correspond to a same identity based on the threshold.

An object of the present disclosure is to provide a method, in which the pre-trained AI model is at least one of a face recognition model and a voice recognition model.

Another object of the present disclosure is to provide a method, in which at least one of the determining the first parameter updates and the determining the second parameter updates includes optimizing only affine parameters in batch normalization layers.

An object of the present disclosure is to provide a method, in which the self-supervised adaptation process and the pair-wise adaptation process are performed directly on embedding representations without utilizing a classifier head trained on source data of the source domain.

Another object of the present disclosure is to provide an artificial intelligence (AI) device including a memory configured to store a pre-trained AI model configured to generate embeddings from input data, and a controller configured to obtain the pre-trained AI model, receive unlabeled target data from a target domain, the target domain having different data characteristics than a source domain used to train the pre-trained AI model, determine first parameter updates for the pre-trained AI model by performing a self-supervised adaptation process based on a correlation between a first input sample and an augmented version of the first input sample, generate an updated AI model based on the first parameter updates, determine second parameter updates for the updated AI model by performing a pair-wise adaptation process based on adjusting embedding representations of a pair of input samples based on a threshold to correspond to a same identity, and generate a final adapted AI model based on the second parameter updates, wherein the final adapted AI model is adapted to the target domain.

Another object of the present disclosure is to provide a non-transitory computer readable medium storing computer-executable instructions that when executed by a processor, cause the processor to perform the operations of obtaining a pre-trained AI model, the pre-trained AI model being configured to generate embeddings from input data, receiving unlabeled target data from a target domain, the target domain having different data characteristics than a source domain used to train the pre-trained AI model, determining first parameter updates for the pre-trained AI model by performing a self-supervised adaptation process based on a correlation between a first input sample and an augmented version of the first input sample, generating an updated AI model based on the first parameter updates, determining second parameter updates for the updated AI model by performing a pair-wise adaptation process based on adjusting embedding representations of a pair of input samples based on a threshold to correspond to a same identity, and generating a final adapted AI model based on the second parameter updates, wherein the final adapted AI model is adapted to the target domain.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4A illustrates an example of a self-supervised adaptation module according to an embodiment of the present disclosure.

FIG. 4B illustrates an example of a pair-wise adaptation module according to an embodiment of the present disclosure.

FIG. 5 illustrates an example flow chart for a method of controlling an AI device configured with IDentity-based Test-Time Adaptation (ID-TTA) to perform model adaptation according to an embodiment of the present disclosure.

FIG. 6 illustrates an overview of the architecture of the pipeline for an ID-TTA AI model, according to an embodiment of the present disclosure.

FIG. 7 illustrates aspects of a pairwise ad adaptation for ID-TTA, according to an embodiment of the present disclosure.

FIG. 8A and FIG. 8B show examples of the embedding space of the model before and after adaptation, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

For simplicity of explanation, a situation of adapting a face recognition model is used an example, but embodiments are not limited thereto. For example, the model adaptation techniques disclosed herein can be applied to other types of AI models, such a voice recognition, text-to-image generation, image-to-text generation, text-to-video generation, language translation, object identification and robot model control, and self-driving AI models, etc. Self-driving refers to a technique of driving for oneself, and a self-driving vehicle refers to a vehicle that travels without an operation of a user or with a minimum operation of a user. For example, the adapted model could better recognize different drivers and passengers and provide personalized services and authentication accordingly.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

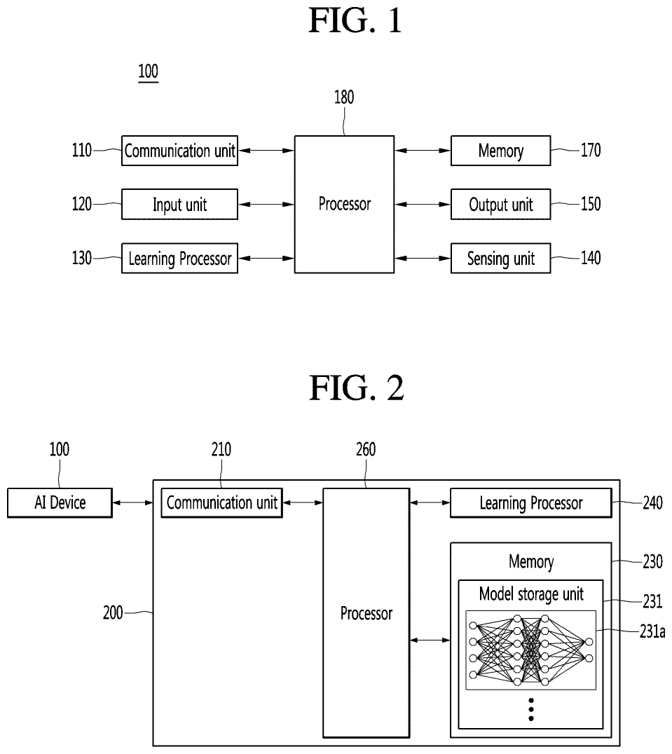

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

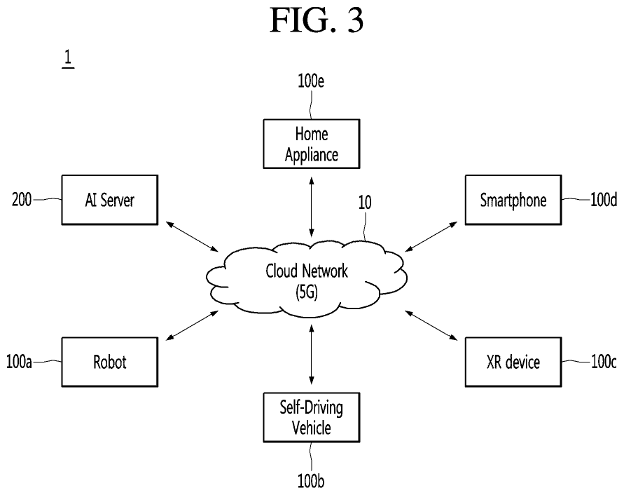

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

Also, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement IDentity-based Test-Time Adaptation (ID-TTA) for a recognition model. Also, the generated output produced by the adapted model can be used by AI systems in various downstream related tasks other than face or voice recognition (e.g., personalized services, object identification, control instructions to move a robot, control maneuvering for a self-driving vehicle, in game content generation personalized to a specific user, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and can determine the specific user from among a plurality of registered users and produce an answer to a query, carry out an action or movement, animate a displayed avatar or a recommend an item or action based on the determined user.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs IDentity-based Test-Time Adaptation (ID-TTA) for AI model processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the ID-TTA AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart hub device, smart television (TV), smart microwave, smart oven, smart washing machine or dryer, smart refrigerator or other display device, which can implement one or more of a user recognition model, a large language model (LLM), a chat-bot, a digital avatar assistant, a question and answering system or a recommendation system, etc. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state or identity of the user.

According to an embodiment, the AI device 100 configured with the IDentity-based Test-Time Adaptation (ID-TTA) AI model can generate an updated recognition model with improved efficiency and accuracy.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

According to an embodiment, the AI device 100 configured with the ID-TTA AI model can better adapt and update a pre-trained metric learning model to new, unlabeled target domain data by directly adapting the model in the embedding space through a combination of self-supervised adaptation which leverages consistency between original samples and their augmentations and pair-wise adaptation that refines representations based on the similarity of sample pairs, thereby enabling robust performance improvements when dealing with domain shifts without requiring access to the original source data, target data labels, or a model classifier during the adaptation process.

As discussed above, existing pre-trained models and recognition technology face several challenges. For example, in many practical applications of machine learning, models are pre-trained on large-scale source datasets and then deployed in various target environments. However, a significant challenge referred to as “domain gap” or “domain shift” arises when the statistical distribution of data encountered in the new target domain differs from that of the source domain upon which the model was trained. This discrepancy can lead to a substantial degradation in model performance, rendering the pre-trained model suboptimal or even unreliable for the target task. Test-Time Adaptation (TTA) techniques have emerged as a class of methods aiming to mitigate this performance drop by adapting the pre-trained model using unlabeled data from the target domain encountered during inference because the source data is not available when adapting the pre-trained model.

However, existing approaches often suffer from several limitations that restrict their applicability and effectiveness, particularly in the context of identity (ID) verification systems or other metric learning applications. For example, techniques that rely on entropy minimization or pseudo-labeling depend on the presence and output of a model's classification head. These methods often seek to optimize an objective function based on the predictive uncertainty or confidence of the classifier's outputs for the unlabeled target data.

However, in many deployed ID systems, such as face recognition or speaker verification systems, the final classification layer used during training is often discarded. Instead, these systems operate by extracting embedding vectors from the input data and performing comparisons directly in the embedding space. Thus, adaptation techniques that presuppose a classifier are rendered inapplicable or require significant, often impractical, modifications to be used with such classifier-free, embedding-centric architectures.

Further, other existing adaption methodologies present challenges related to data dependencies and operational practicalities. Some approaches may implicitly or explicitly require access to, or statistics from, the original source training data during the adaptation phase, which is frequently infeasible due to privacy constraints, data ownership issues, or the sheer volume of the source data.

Similarly, while test time adaptation primarily targets adaptation with unlabeled target data, the robustness and calibration of some methods can be sensitive or might not fully address the challenge without at least some form of weak supervision or auxiliary information that is not always available. Issues such as catastrophic forgetting, where adaptation to a new target domain leads to a loss of previously learned knowledge from the source domain or prior target domains, also remain a concern.

Additionally, the computational overhead introduced by certain adaptation algorithms can be prohibitive for real-time applications or deployment on resource-constrained edge devices (e.g., the end user device). These deficiencies underscore a need for improved model adaption methods that can effectively operate under the typical constraints of deployed ID systems, particularly those that are classifier-free and where source data and target labels are unavailable.

According to embodiments, a method and device is provided for performing test-time adaptation of a pre-trained machine learning model, particularly a model utilized in an identification (ID) system, such as face or voice recognition. The IDentity-based Test-Time Adaptation (ID-TTA) AI model can address the challenge of performance degradation when a model that has been pre-trained on source domain data, is then deployed in a target domain with different data characteristics (e.g., a phenomenon referred to as “domain gap” or “domain shift”). Unlike existing adaptation techniques that often rely on the output of a classifier or require access to source data or target data labels, the ID-TTA AI model can provide a different approach for adapting models directly in the embedding space without such dependencies.

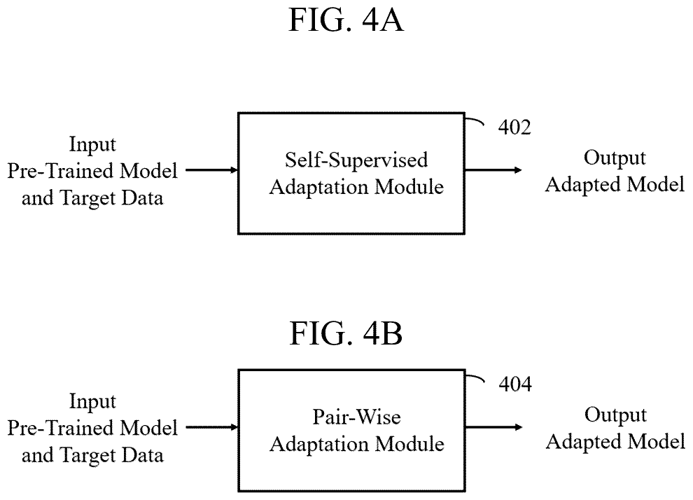

With reference to FIG. 4A and FIG. 4B, the disclosed IDentity-based Test-Time Adaptation (ID-TTA) method can include at least two adaptation modules (e.g., 402, 402) configured to adjust a pre-trained model using unlabeled target domain data to generate an updated model that is specifically adapted to the new target environment, according to embodiments (e.g., FIG. 4A, 402). According to embodiments, the adaptation modules can be implemented in series according to either order (e.g., 402 then 404, or 404 then 402).

According to an embodiment, a first module 402 (e.g., a self-supervised adaptation module) can operate on individual input samples or batches thereof from the target domain. The self-supervised adaptation module 402 can create one or more augmented views of an input sample (e.g., through transformations like rotation, translation, blur, etc.) and then compute embeddings for both the original sample and its augmented view(s). An objective function, such as one based on maximizing the agreement or correlation between the embeddings of the original sample and its augmented view, can then be used to generate a loss signal for model adaptation.

According to an embodiment, a second module 404 (e.g., a pair-wise adaptation module) can operate on pairs of input samples from the target domain. The pair-wise adaptation module can compute embeddings for the pair of input samples and based on a similarity or distance metric between these embeddings (e.g., and possibly a dynamic threshold indicative of a same or different identity) the pair-wise adaptation can generate a loss signal to update the model parameters, which can encourage more consistent representations for samples presumed to be from the same identity (e.g., FIG. 4B, 404).

According to another embodiment, the method can include implementing only the self-supervised adaptation module to generate an updated recognition model. Also, according to an embodiment, the method can include implementing only the pair-wise adaptation module to generate an updated recognition model.

Further, these adaptation modules can be applied iteratively or sequentially to refine the model's performance on the target domain data. For example, the self-supervised adaptation process can be applied to adapt a pre-trained recognition model (e.g., face or voice recognition), and then the pair-wise adaptation process can be applied to further adapt and improve the recognition model to generate an updated model that is specifically adapted to the new target environment. Then the user can use the updated model with improved accuracy and convenience.

Alternatively, the pair-wise adaptation process can be applied to adapt a pre-trained recognition model, and then the self-supervised adaptation process can be applied to further adapt and improve the recognition model to generate an updated model that is adapted to the new target environment.

Also, by operating directly on embeddings and leveraging self-generated supervisory signals, the method can enable robust adaptation of ID systems in a classifier-free and data-efficient manner, according to an embodiment.

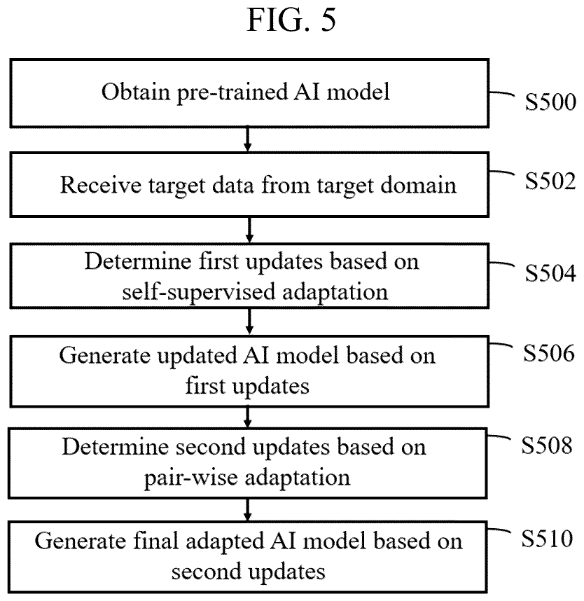

FIG. 5 shows an example flow chart of a method according to an embodiment. For example, according to an embodiment, a method for controlling an AI device can include obtaining, by a processor in the AI device, a pre-trained AI model configured to generate embeddings from input data (e.g., S500), receiving unlabeled target data from a target domain different than a source domain used to train the pre-trained AI model (e.g., S502), determining first parameter updates for the pre-trained AI model by performing a self-supervised adaptation process based on a correlation between a first input sample and an augmented version of the first input sample (e.g., S504), generating an updated AI model based on the first parameter updates (e.g., S506), determining second parameter updates by performing a pair-wise adaptation process based on adjusting embedding representations of a pair of input samples based on a threshold to correspond to a same identity (e.g., S508), and generating a final adapted AI model based on the second parameter updates, the final adapted AI model being adapted to the target domain (e.g., S510).

According to an embodiment, a method of controlling an AI device can be include obtaining, by a processor (e.g., controller), a pre-trained AI model trained on a source dataset and is configured to generate numerical embeddings or feature vectors from input data, such as images or audio signals. Concurrently, or subsequently, the processor can also obtain unlabeled target data originating from a target domain. The target domain can exhibit different data characteristics compared to the source domain on which the pre-trained AI model was initially trained, leading to potential performance degradation if the model is not adapted.

In addition, once the pre-trained AI model and the unlabeled target data are available, the processor, in an embodiment, can perform a self-supervised adaptation process on the pre-trained AI model. The self-supervised adaptation process can use at least a first portion of the unlabeled target data and can generate a first adapted AI model (e.g., a first updated version). The self-supervised adaptation process, in this embodiment, includes several steps. First, for each of a plurality of original input samples obtained from the first portion of the unlabeled target data, a corresponding augmented view is generated. Each such augmented view is carefully created to preserve the core identity of its corresponding original input sample while altering other, often superficial, characteristics. For example, if the input samples are images, augmentations might include rotations, translations, or changes in brightness, which alter the image's appearance but not the identity of the subject depicted.

Further, after the generation of augmented views, the pre-trained AI model can process both the plurality of original input samples and their corresponding augmented views. This processing results in the generation of a set of original embeddings for the original input samples and a set of augmented embeddings for the augmented views. A self-supervised adaptation loss is then calculated based on the relationship between these sets of original and augmented embeddings. According to an embodiment, this loss function is specifically configured to achieve two primary objectives: first, to increase the similarity (or decrease the distance) between an original embedding of an input sample and the augmented embedding of that same sample's corresponding augmented view, thereby promoting invariance to the augmentations. Second, the loss is configured to decrease the similarity (or increase the distance) between the original embedding of an input sample and augmented embeddings that correspond to different original input samples within the plurality, which helps in reducing feature redundancy and improving discriminability. The parameters of the pre-trained AI model are subsequently updated based on this calculated self-supervised adaptation loss, yielding the first adapted AI model.

In addition, after the generation of the first adapted AI model through the self-supervised process, the method, in an embodiment, proceeds with performing a pair-wise adaptation process. This second adaptation stage can be performed by the processor on the first adapted AI model and utilizes at least a second portion of the unlabeled target data (e.g., which may or may not overlap with the first portion). The pair-wise adaptation process can begin by selecting a pair of input samples from this second portion of the unlabeled target data. The first adapted AI model then processes this pair of input samples to generate a pair-embeddings.

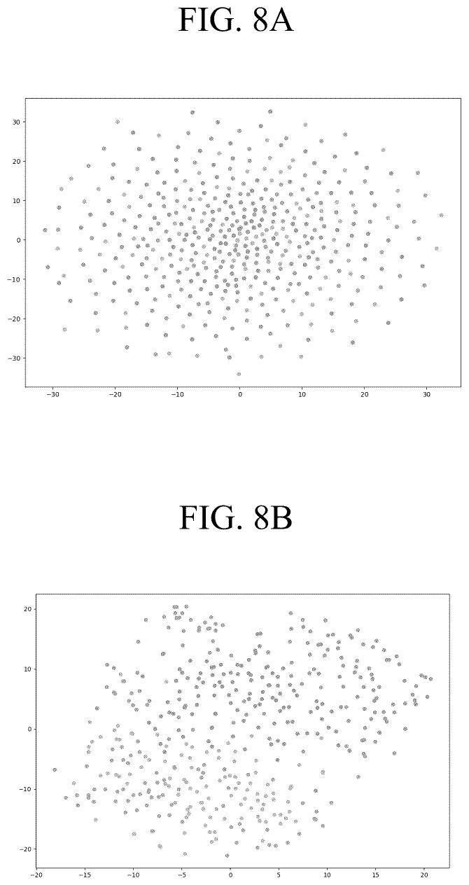

Further, a measure of relatedness can be determined between the pair of embeddings. This measure can be, for example, a similarity score (such as cosine similarity) or a distance value (such as Euclidean distance). Based on this determined measure of relatedness and a predefined or dynamically adjusted threshold, a determination can be made as to whether the pair of input samples represent the same underlying identity. If the pair of input samples is determined to represent the same identity, a pair-wise adaptation loss is calculated. This loss is configured to encourage either an increased similarity or a decreased distance between the pair of embeddings, effectively pulling representations of same-identity samples closer together in the embedding space (e.g., see FIG. 8B). The parameters of the first adapted AI model are then updated based on this pair-wise adaptation loss.

Then the AI model that results from this pair-wise adaptation process, incorporating the parameter updates from said process, is generated as an updated AI model. This updated AI model, having undergone one or both of the described adaptation processes, is now better adapted to the specific characteristics of the unlabeled target data which leads to improved performance in the target domain.

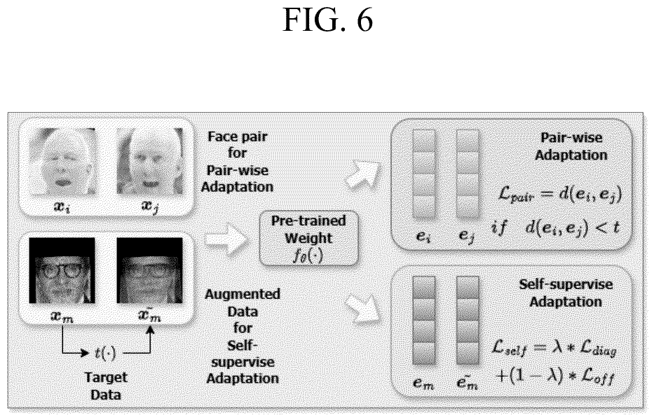

For example, with reference to FIG. 6 (e.g., bottom portion), according to an embodiment, the method can include applying a self-supervised adaptation process to a pre-trained model (e.g., a pre-trained face recognition model).

According to an embodiment, the self-supervised adaptation module can be configured to adapt the pre-trained embedding model using only the unlabeled input data samples themselves as a source of supervision. The self-supervised adaptation module can operate on the principle of invariance to encourage the model to produce consistent embedding representations for an input sample and augmented versions of that same sample, in order to refine the model's understanding of identity-preserving features relevant to the target domain. This adaptation can occur at test-time by utilizing batches of incoming data from the target domain without requiring any predefined labels or access to the original source training data.

Further, according to an embodiment, the self-supervised adaptation module can receive a batch of input data samples. For example, the samples can be images in a face recognition system, audio segments in a voice recognition system, or other forms of data where metric learning is applicable.

For each original input sample in the batch, the self-supervised adaptation module can generate at least one corresponding augmented view. The augmentation techniques employed can alter non-essential characteristics of the input sample while preserving its core identity. For instance, in the case of image data, augmentations can include, but are not limited to, random rotations, translations, cropping, scaling, color jittering, blurring, or the addition of noise. For audio data, augmentations can include changes in speed, pitch, volume, or the introduction of background noise. Also, the typo of transformation applied can be selected at random from a plurality of available transformations, but embodiments are not limited thereto.

In addition, as shown in FIG. 6, one the original batch of samples (e.g., x) and the corresponding batch of augmented views (e.g., [symbol] ) are prepared, both batches can be processed by the current state of the adaptable embedding model, which has model weights or parameters subject to adaptation. This processing can yield two sets of embedding vectors, such as a set of original embeddings and a set of augmented embeddings. Each of the original embeddings can correspond to an original sample (e.g., x), and each of the augmented embeddings can correspond to one of the augmented views (e.g., x). According to an embodiment, these embeddings can be normalized vectors residing in a high-dimensional embedding space.

Also, the self-supervised adaptation module can optimize an objective function designed to maximize the agreement between the embeddings of original samples and their respective augmented views, while simultaneously minimizing redundancy between representations of different samples.

According to embodiments, the self-supervised adaptation module can compute a cross-correlation matrix between the batch-wise embeddings (e.g., batches of original embeddings and augmented embeddings). The cross-correlation matrix can be an N×N matrix (where N is the batch size). The objective can be to drive this cross-correlation matrix C towards an identity matrix. For example, according to an embodiment, the diagonal elements (e.g., representing the similarity between an original sample x and its own augmented view \tilde{x}) should be close to 1, encouraging invariance. Conversely, the off-diagonal elements should be close to 0, encouraging separability and reducing redundancy in the learned representations.

In addition, according to an embodiment, the self-supervised adaptation module can have a loss function based on the computed cross-correlation matrix C. The loss function can include two terms. For example, the first term (e.g., an invariance term) can penalize deviations of the diagonal elements from 1. Further in this example, the second term of the loss function (e.g., a redundancy reduction term) can penalize non-zero off-diagonal elements.

Further, these two terms can be weighted by respective hyperparameters. The total self-supervised loss can then be used to compute gradients with respect to the parameters or weights of the embedding model. According to an embodiment, these gradients can be used by an optimization algorithm, such as stochastic gradient descent (e.g., SGD) or variants (e.g., Adam), to update the model parameters or weights θ. This update step can adjust the model so that it becomes more adept at producing consistent and distinct embeddings for the target domain data, based purely on the self-generated supervisory signal from the data augmentation and correlation optimization process. Further, this self-supervised adaptation process can be performed iteratively on successive batches of target domain data to adapt the model to generate an updated model that is specific to the new target domain (e.g., adapted to the end user's specific environment and conditions).

According to an embodiment, the ID-TTA model can improve efficiency by only optimizing the affine parameters in each batch normalization layer, but embodiments are not limited thereto. According to another embodiment, the ID-TTA model can optimize all the parameters and weights of the model.

In more detail, with reference to FIG. 6, the self-supervised adaptation module can use input data (e.g., xₘ) together with augmented data (e.g., \tilde{x}ₘ) and can aim to maximize the agreement between two samples.

For example, given a single input image, a new view of the sample input image can be created by first randomly sampling an image transform and then applying the transform on the input image, \tilde{x}=t(x), t˜T, ∀x∈Dₜ, where T is a set of transform functions. For example, the augmented view can be created by using image transform functions for each sample image in the batch (e.g., translate, rotate, blur, etc.). Thus, the new view can share the same label as the input sample.

For example, given a batch of N samples, B={x₁, x₂, . . . , xₙ,}, a new view can be created for each sample in the batch, [symbol] ={x^{˜}₁, x^{˜}₂, . . . , x^{˜}ₙ}. Then both batches can be passed to the face model to extract their embeddings, (E, [symbol] )=f_{θ}(B, [symbol] )}, E, [symbol] ∈R^{N×d}, where d is the dimensionality of the embedding. The agreement between the two embeddings (E, [symbol] ) can be maximized because the embeddings are from the same user (e.g., from the same user face).

Further in this example, The correlation matrix for the two embeddings can be formulated by ρ=1/N (corr(E, E″)), ρ∈R^{d×d}.

The loss for the self-supervised adaptation can be grouped into diagonal and off-diagonal, denoted as L_{diag} and L_{off} respectively, as shown in Equation 1, below.

$$\begin{matrix}{ℒ}_{diag} & = \frac{1}{d} {\sum }_{i , j = 1}^{d} {( 1 − {ρ}_{i j} )}^{2} , if i = j ,\end{matrix} \qquad [ Equation 1 ]$$

$${ℒ}_{off} \qquad = \frac{1}{d ( d − 1 )} {\sum }_{i , j = 1}^{d} {ρ}_{i j}^{2} , if i \neq j ,$$

$$\begin{matrix}∀ i , j & = 1 , 2 , … , d\end{matrix}$$

Then the combined loss for the self-supervised adaptation can defined as a

weighted combination: L_{self}=λL_{diag}+(1-λ)L_{off}. For example, λ can be set to 0.3, but embodiments are not limited thereto.

For example, the average of the diagonal element of ρ can be taken, which can be denoted as {ρᵢⱼ| for i, j=1, . . . , d, i=j.}=diag(ρ).

In addition, according to an embodiment, the self-supervised adaptation process can emphasize efficiency by generating only one augmented view per sample, and additional projector parameters can be omitted and the adaptation can be applied directly to the embeddings of the face model, but embodiments are not limited thereto.

In this way, according to an embodiment, the self-supervised adaptation module can refine an embedding model (e.g., pre-trained face model or voice model) using unlabeled target data by generating identity-preserving augmented views of input samples, processing both original and augmented samples through the model to obtain their respective embeddings, and then optimizing the model's parameters to maximize similarity between embeddings of each original sample and its corresponding augmented view while simultaneously minimizing similarity between that original sample's embedding and embeddings from augmented views of other distinct samples, thereby generating an adapted or updated model that has improved discriminative capabilities on the target domain without needing external labels or the source data (e.g., original training data).

In addition, with reference again to FIG. 6 (e.g., top portion), according to an embodiment, the method can include applying a pair-wise adaptation process to a pre-trained model (e.g., a pre-trained face recognition model or voice recognition model) or the pair-wise adaptation process can be applied to the updated/adapted model generated by the self-supervised adaptation module (e.g., in a sequential adaptation/update scenario).

According to an embodiment, the pair-wise adaptation module can be configured to adapt the pre-trained embedding model by leveraging relationships between pairs of unlabeled input data samples encountered in the target domain during test-time (e.g., when deployed at the end user's home, such as during a configuration phase or an initial trail phase). For example, the pair-wise adaptation module can refine the embedding space such that samples predicted to belong to the same identity are represented by more proximate embeddings, thereby enhancing the model's discriminative capability and robustness to variations present in the target domain data. This pair-wise adaptation can be performed without requiring explicit labels for the target data or access to the original source training data.

Further in this example, the pair-wise adaptation module can process input data samples received in batches, although other schemes such as processing samples sequentially or against a reference gallery can be used, according to embodiments. For a given set of input samples from the target domain (e.g., pictures taken of the user at different time or at different angles, etc.), pairs of samples are considered for adaptation. For each sample within a selected pair, the current state of the adaptable embedding model can be used to compute their respective embedding vectors. These embeddings represent the input samples in a learned high-dimensional space where proximity is indicative of similarity.

Also, after the embedding generation, a similarity or distance metric can be computed between the two embeddings of the paired samples. For example, the comparison metrics used can include, but are not limited to, cosine similarity, Euclidean distance, or Mahalanobis distance. According to a preferred embodiment, Euclidean distance can be used, but embodiments are not limited thereto.

In addition, the pair-wise adaptation module can determine whether the pair of samples likely belong to the same underlying identity. This determination can be made by comparing their calculated similarity (or distance) to a predefined threshold (e.g., learned from the original source data) or a dynamically adjusted threshold, τ. For instance, if the distance between the two vector embeddings is less than τ, or if the similarity s is greater than τ, the pair can be determined to be a “positive pair” or a “positive match” (e.g., a pair of samples corresponding to the same identity).

Also, the threshold τ can be established in various ways, according to embodiments. For example, according to an embodiment, threshold τ can be a fixed threshold that is predetermined based on validation on the source training dataset or a similar representative dataset, reflecting a general boundary for intra-identity versus inter-identity variations.

According to an embodiment, the threshold τ can be a dynamic threshold. For example, the dynamic threshold can be adjusted during test-time adaptation by comparing embeddings generated by the adaptable model with embeddings generated by a frozen, non-adapted copy of the original pre-trained model. Discrepancies or consistencies in similarity predictions between these two models for the same pairs can be used to inform the adjustment of threshold τ, allowing it to better reflect the current state of the adapting model and the characteristics of the target domain data. For example, the distance between embeddings generated by a frozen, non-adapted copy of the original pre-trained model can be considered as a dynamic threshold, t. Then the embeddings of the same input data generated by the adapted model (e.g., distance “a”) will be compared against the threshold t. If the distance “a” is smaller than the threshold t, then the input data pair is considered from the same person, and the model will be optimized accordingly.

For example, if a pair of samples is predicted as belonging to the same identity (e.g., a positive pair or positive match), a loss function can be used to encourage their embeddings to become more similar. For example, the loss can be directly proportional to the distance d between the two vector embeddings if the objective is to minimize this distance, or it can be related to the negative of their similarity if the objective is to maximize similarity, but embodiments are not limited thereto. The specific form of the loss function can vary according to embodiments, but the loss function can be used to penalize the model when presumed positive pairs have embeddings that are not sufficiently close.

Further in this example, the calculated pair-wise loss can then be used to compute gradients with respect to the parameters or weights (e.g., θ) of the embedding model (e.g., fθ). These gradients can be used by an optimization algorithm, such as stochastic gradient descent (SGD) or variants (e.g., Adam), to update the model parameters or weights θ. This update step can incrementally adjust the embedding space to better cluster samples presumed to be from the same identity together with each other, thereby improving the model's performance on the target domain data.

According to an embodiment, the ID-TTA model can improve efficiency by only optimizing the affine parameters in each batch normalization layer, but embodiments are not limited thereto. According to another embodiment, the ID-TTA model can optimize all the parameters and weights of the model.

For example, the embedding space of the model can be updated so that samples corresponding to different identities (e.g., non-matching pairs) have corresponding embedding vectors that are located farther apart, and samples corresponding to the same identity (e.g., matching pairs) have corresponding embedding vectors that are located closer together within the embedding space.

Also, according to an embodiment, the pair-wise adaptation module can operate iteratively on successive pairs or batches of data encountered at test-time and can function in conjunction with other adaptation modules, such as the self-supervised adaptation module to update or further update a pre-trained recognition module.

In more detail, with reference again to FIG. 6, the pair-wise adaptation module can optimize the pre-trained model by encouraging closer or similar representations of (eᵢ, eⱼ) if the two embeddings are of the same identity. For example, the Euclidean distance can be minimized between the pair, ↓ d(eᵢ, eⱼ). An issue could arise because the data pair is not labeled. To generate pseudo-labels, a threshold can be set on the target data. According to an embodiment, a threshold can be determined by applying k-fold validation on the labeled source data. The chosen fixed threshold can then be used directly on the target data as a criterion, and the pair-wise adaptation can be applied accordingly.

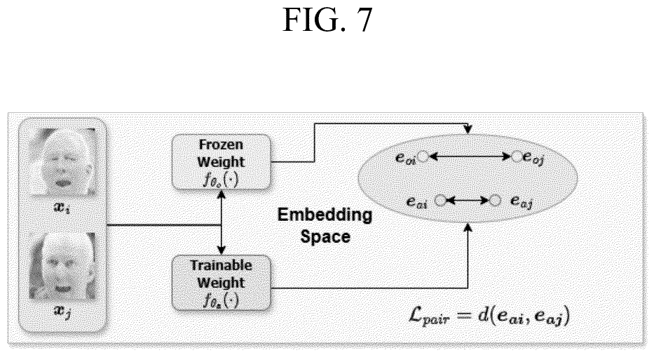

However, with reference to FIG. 7, the pair-wise adaptation module can apply a dynamic threshold based on the target domain to improve the adaptation performance even further. For example, two copies of the pre-trained model can be created, a first model copy θa can be optimized for adaptation, and a second model copy θ0 can be a frozen version of the original weights (e.g., initially θₐ=θₒ).

Further in this example, with reference to FIG. 7, the dynamic threshold can be chosen by t=d(eₒᵢ, eₒⱼ), (eₒᵢ, eₒⱼ)=f_{θo} (xᵢ, xⱼ). The pair-wise information can be optimized if the embeddings from the adapted model are closer together than the frozen model, e.g., d(eₐᵢ, eₐⱼ)<t, (eₐᵢ, eₐⱼ)=f_{θa} (xᵢ, xⱼ). The threshold is dynamic because it varies based on the difficulty of the input pair, thus the dynamic threshold can better utilize the information of the target domain than the fixed threshold. The loss for the adaptation model weight θₐ can be formulated in Equation 2, below.

$${arg min}_{{θ}_{a}} {ℒ}_{pair} = d ( {e}_{i} , {e}_{j} ) , if d ( {e}_{i} , {e}_{j} ) < t \qquad [ Equation 2 ]$$

For example, the pair-wise adaptation module can receive a pair of face images (e.g., x1, x2), and can try to predict if the two different images are from the same identity (e.g., two different pictures of the same user). The pre-trained model can compute the vector embeddings for the pair of inputs, e.g., (e1, e2)=fₒ(x1, x2), where e1 and e2 are the two vector embeddings.

Then the pair-wise adaptation module can measure the distance or similarity on the two embeddings. According to an embodiment, the pair-wise adaptation module can apply the Euclidean distance denoted as d(e1, e2). If the Euclidean distance is shorter than a pre-defined threshold (e.g., the pre-defined threshold selected based on the source data), the pair of the faces are predicted as being from the same identity. Thus, the distance can be further minimized, vice versa for cosine similarity. Then parts of the model and the entire model can be optimized based on the distance loss, Lₚₐᵢᵣ=d(e1, e2).

In other words, the pair-wise adaptation process can refine an adaptable embedding model using unlabeled target domain data by processing pairs of input samples, in which for each pair, respective embeddings are generated by the model and their similarity or distance is assessed against a threshold, which can be fixed or dynamically adjusted, to determine if the two samples originate from a common identity. Also, if a pair is deemed to represent the same identity, the model's parameters or weight can then be optimized to reduce the distance or increase the similarity between their embeddings, which can improve the model's ability to cluster same-identity samples more closely together in the embedding space for enhanced performance on the target domain without requiring explicit labels or access to original source data.

Further, as discussed above, the AI device configured with the ID-TTA model can obtain a pretrained model (e.g., a face recognition model or voice recognition model) and can sequentially apply the self-supervised adaptation process to generate an updated model (adapted model) and then apply the pair-wise adaptation process on the updated model to generate a further updated model (further adapted model), which is more accurately adapted to the new target data (e.g., specifically tailored to the user's home environment and local conditions).

Also, according to another embodiment, the AI device configured with the ID-TTA model can obtain a pretrained model (e.g., a face recognition model or voice recognition model) and can sequentially apply the pair-wise adaptation process to generate an updated model (adapted model) and then apply the self-supervised adaptation process on the updated model to generate a further updated model (further adapted model), which is more accurately adapted to the new target data.

Various experiments were carried out against related art models to evaluate the results. For example, the face model was trained on the source dataset (clean dataset) Web-Face. Then the model was evaluated on five different face sets. To simulate target data, different image corruptions were applied on each image to build the target distribution, such as brightness, contrast, shot noise.

As shown in Table I below, the AI model according to embodiments either outperforms other related-art methods and has a lower error rate.

TABLE I

| Method | LFW(Val.) | CFP-FP | CPLFW | CALFW | AGEDB-30 | Avg. |
|---|---|---|---|---|---|---|
| No Adapt† | 0.9 | 5.6 | 11.7 | 7.8 | 7.4 | 8.1 |
| No Adapt | 22.4 | 31.3 | 36.2 | 31.9 | 34.5 | 33.4 |
| BN | 19.9 | 32.5 | 35.2 | 28.4 | 33.1 | 32.3 |
| Pair-wise | 17.6 | 29.1 | 34.4 | 27.9 | 31.2 | 30.6 |
| Self-supervised | 13.0 | 23.7 | 29.0 | 23.7 | 26.5 | 25.7 |
| ID-TTA(with both) | 11.4 | 21.0 | 28.5 | 22.8 | 25.7 | 24.5 |

As shown above, comparison of ID-TTA on different shifted face datasets was carried out. The LFW dataset was used as a validation set for hyper-parameter tuning; the average error rate on the other four datasets, CFP-FP, CPLFW, CALFW, and AGEDB-30, are reported in percentages to showcase the efficacy. Also, No Adaptt shows the error rate of the model on the source (clean) datasets (e.g., implementation in the source domain); the rest of the results (lines 2-6) are on the target (corrupted) data for TTA comparison (e.g., implementation in the target domain). The lowest error rate is highlighted in bold, which is the ID-TTA model according to an embodiment, in which both self-supervised adaptation and pair-wise adaptation were applied to generate the updated model.

Also, FIG. 8A show a visualization representation of the embedding space before adaptation has been applied to the original, pre-trained model (e.g., different embeddings are relatively evenly mixed and dispersed). And FIG. 8B shows a visualization representation of the embedding space after adaptation has been applied to the original, pre-trained model to generate the updated model that is specifically adapted to the target domain. For example, as shown, the embedding space is more separable after applying the ID-TTA process (e.g., similar embedding are clumped closer together, or in rough groupings).

According to an embodiment, the AI device 100 can be configured to provide improved adaptation of an artificial intelligence (AI) model. The AI device 100 can be used in various types of different situations.

According to one or more embodiments of the present disclosure, the AI device 100 can solve one or more technological problems in the existing technology, such as performing IDentity-based Test-Time Adaptation (ID-TTA) to provide enhanced recognition accuracy in previously unseen target domains and efficient classifier-free model adaptation directly in the embedding space, while operating without reliance on source data or target domain labels.

According to an embodiment, the AI device 100 configured with the ID-TTA AI model can overcome limitations in the existing technology by providing robust classifier-free adaptation directly within the embedding space, rendering it highly effective for deployed identity and metric learning systems where classifiers are typically absent. This approach inherently addresses performance degradation from domain shifts and is well-suited for challenging open-set recognition tasks in such systems.

In addition, according to an embodiment, the AI device 100 configured with the ID-TTA AI model can have a hybrid methodology, combining self-supervised adaptation and pair-wise adaptation which can achieve superior error reduction on domain-shifted data. The method can provide improved efficiency by enabling deployment on resource-constrained devices, e.g., by selectively optimizing key model parameters (e.g., the affine parameters of the BN layers). It also offers operational versatility through flexible thresholding mechanisms and demonstrates robust performance across diverse on-line and continual adaptation scenarios.

Also, according to an embodiment, the AI device 100 configured with the ID-TTA AI model can be used in a mobile terminal, a smart TV, a home appliance, a robot, an infotainment system in a vehicle, etc.

Further, according to an embodiment, the AI device 100 including the ID-TTA AI model can implement a method that can provide a more efficient, accurate recognition model.

For example, the AI device can be applied in a wide range of interactive applications including a digital assistant, a question and answering system, and a home robot. For example, according to an embodiment, the home robot can identify and determine different users and based on this information, the robot can perform a more relevant helping or caring action, or provide a better answer or information that more accurately addresses the user's needs, such as providing personalized services.

In addition, the ID-TTA AI model can be applied to a variety of real-world systems, particularly those involving identity (ID) verification or recognition that rely on metric learning techniques, often operating in an open-set configuration where the system needs to distinguish known individuals from a large, undefined set of unknown individuals. Also, a utility of the ID-TTA TTA model in these applications lies in its ability to dynamically adapt a pre-trained model to specific user data or environmental conditions encountered during deployment, thereby mitigating the performance degradation typically caused by domain shifts between the initial training data and the operational data. This leads to more robust, reliable, and accurate identification systems, directly enhancing end-user satisfaction and system efficacy.

Further, the ID-TTA method can be applied to is in face recognition systems. Such systems are integral to a multitude of end-user products and services. For example, smartphones and personal computing devices commonly employ face recognition for secure unlocking and application authentication. Security and access control systems in residential, commercial, and governmental facilities utilize face recognition to grant or deny entry. Furthermore, smart home devices, automotive systems, and even retail analytics can incorporate face recognition for personalization or identification. In these varied deployments, the pre-trained face recognition models invariably encounter diverse conditions not fully represented in their source training data, such as variations in ambient lighting, camera quality specific to the user's device, occlusions (e.g., new eyeglasses, face masks, outfits, hats, etc.), changes in user appearance over time (e.g., aging), or different demographic attributes. By integrating the ID-TTA process, such face recognition systems can adapt on-the-fly, for instance, to the specific lighting conditions in a user's home when unlocking a smart door, or to the particular camera characteristics of a newly acquired smartphone, resulting in consistently higher recognition accuracy and a more seamless user experience.

Another area of application for the ID-TTA method is in voice recognition and speaker verification systems. These systems are foundational to voice-activated assistants on smartphones and smart speakers (e.g., for issuing commands or accessing personalized information), dictation software, voice-based biometric security measures, and in-vehicle infotainment and control systems. Similar to face recognition, voice recognition models pre-trained on large, generic datasets often face challenges when deployed due to domain shifts arising from factors such as the user's specific microphone acoustics (e.g., on a low-cost headset versus a high-fidelity microphone), unique vocal characteristics or accents, varying speaking styles or speeds, changing user health conditions, and prevalent background noise in the user's environment (e.g., in a moving vehicle, a busy office, or a quiet room). The ID-TTA method can enable these voice recognition systems to adapt to the particular acoustic environment and vocal patterns of the end-user. For example, a voice assistant on a user's smartphone can become better attuned to a specific user's voice even in noisy public spaces, or a car's voice control system can adapt to the specific noise profile within the vehicle cabin, leading to improved command recognition, reduced frustration, and enhanced operational reliability.

Another advantage to the broad applicability of the ID-TTA method is for user-centric devices and its potential for efficient implementation. In certain embodiments, such as when adaptation primarily involves tuning specific layers of the neural network (e.g., Batch Normalization layers), the computational overhead of the ID-TTA process can be substantially minimized. This efficiency makes ID-TTA exceptionally well-suited for deployment and continuous adaptation directly on edge devices or user devices which often have limited computational power and memory resources, such as mobile phones, wearable technology, smart home hubs, and embedded systems in vehicles. On-device adaptation using ID-TTA can not only improve performance but can also enhance user privacy, as sensitive biometric data may not need to be transmitted to a central server for adaptation, and can lead to faster response times by processing data locally.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, by a processor in the AI device, a pre-trained AI model, the pre-trained AI model being configured to generate embeddings from input data;
receiving, by the processor, unlabeled target data from a target domain, the target domain having different data characteristics than a source domain used to train the pre-trained AI model;
determining, by the processor, first parameter updates for the pre-trained AI model by performing a self-supervised adaptation process based on a correlation between a first input sample and an augmented version of the first input sample;
generating, by the processor, an updated AI model based on the first parameter updates;
determining, by the processor, second parameter updates for the updated AI model by performing a pair-wise adaptation process based on adjusting embedding representations of a pair of input samples based on a threshold to correspond to a same identity; and
generating, by the processor, a final adapted AI model based on the second parameter updates, wherein the final adapted AI model is adapted to the target domain.

2. The method of claim 1, further comprising:
receiving, by the processor, a new input sample corresponding to a user and determining an identity of the user based on the final adapted AI model.

3. The method of claim 1, wherein the generating the augmented version of the first input sample includes applying a transformation to the first input sample that preserves an identity of the first input sample while altering other visual or acoustic characteristics of the first input sample.

4. The method of claim 3, wherein the transformation is randomly selected from a predefined set of transformations including at least one of a rotation, a translation, a crop, a scaling, a color jitter, a blur, an addition of noise, a change in audio speed, a change in audio pitch, and a change in audio volume.

5. The method of claim 1, wherein the self-supervised adaptation process includes:
determining the first parameter updates based on optimizing a correlation matrix computed from embeddings of a plurality of input samples including the first input sample and embeddings of corresponding augmented versions,
wherein the optimizing increases correlation for embeddings derived from a same input sample and a corresponding augmented version.

6. The method of claim 1, wherein the threshold used in the pair-wise adaptation process is a dynamic threshold adjusted based on a comparison of embeddings generated by the updated AI model for the pair of input samples and embeddings generated by a frozen, non-adapted copy of the pre-trained AI model for the pair of input samples.

7. The method of claim 1, wherein the adjusting the embedding representations of the pair of input samples to correspond to a same identity is based on minimizing a distance metric between embeddings of the pair of input samples when the pair of input samples is determined to correspond to a same identity based on the threshold.

8. The method of claim 1, wherein the pre-trained AI model is at least one of a face recognition model and a voice recognition model.

9. The method of claim 1, wherein at least one of the determining the first parameter updates and the determining the second parameter updates includes optimizing only affine parameters in batch normalization layers.

10. The method of claim 1, wherein the self-supervised adaptation process and the pair-wise adaptation process are performed directly on embedding representations without utilizing a classifier head trained on source data of the source domain.

11. An artificial intelligence (AI) device, comprising:
a memory configured to store a pre-trained AI model configured to generate embeddings from input data; and
a controller configured to:
obtain the pre-trained AI model,
receive unlabeled target data from a target domain, the target domain having different data characteristics than a source domain used to train the pre-trained AI model,
determine first parameter updates for the pre-trained AI model by performing a self-supervised adaptation process based on a correlation between a first input sample and an augmented version of the first input sample,
generate an updated AI model based on the first parameter updates,
determine second parameter updates for the updated AI model by performing a pair-wise adaptation process based on adjusting embedding representations of a pair of input samples based on a threshold to correspond to a same identity, and
generate a final adapted AI model based on the second parameter updates, wherein the final adapted AI model is adapted to the target domain.

12. The AI device of claim 11, wherein the controller is further configured to:
receive a new input sample corresponding to a user and determine an identity of the user based on the final adapted AI model.

13. The AI device of claim 11, wherein the controller is further configured to:
generate the augmented version of the first input sample by applying a transformation to the first input sample that preserves an identity of the first input sample while altering other visual or acoustic characteristics of the first input sample.

14. The AI device of claim 13, wherein the controller is further configured to:
randomly selected the transformation from a predefined set of transformations including at least one of a rotation, a translation, a crop, a scaling, a color jitter, a blur, an addition of noise, a change in audio speed, a change in audio pitch, and a change in audio volume.

15. The AI device of claim 11, wherein the controller is further configured to:
determine the first parameter updates based on optimizing a correlation matrix computed from embeddings of a plurality of input samples including the first input sample and embeddings of corresponding augmented versions,
wherein the optimizing increases correlation for embeddings derived from a same input sample and a corresponding augmented version.

16. The AI device of claim 11, wherein the threshold used in the pair-wise adaptation process is a dynamic threshold adjusted based on a comparison of embeddings generated by the updated AI model for the pair of input samples and embeddings generated by a frozen, non-adapted copy of the pre-trained AI model for the pair of input samples.

17. The AI device of claim 11, wherein the controller is further configured to:
adjust the embedding representations of the pair of input samples to correspond to a same identity based on minimizing a distance metric between the embedding representations of the pair of input samples when the pair of input samples is determined to correspond to a same identity based on the threshold.

18. The AI device of claim 11, wherein the pre-trained AI model is at least one of a face recognition model and a voice recognition model.

19. The AI device of claim 11, wherein at least one of the first parameter updates and the second parameter updates includes optimizing only affine parameters in batch normalization layers.

20. A non-transitory computer readable medium storing computer-executable instructions that when executed by a processor, cause the processor to perform the operations of:
obtaining a pre-trained artificial intelligence (AI) model, the pre-trained AI model being configured to generate embeddings from input data;
receiving unlabeled target data from a target domain, the target domain having different data characteristics than a source domain used to train the pre-trained AI model;
determining first parameter updates for the pre-trained AI model by performing a self-supervised adaptation process based on a correlation between a first input sample and an augmented version of the first input sample;
generating an updated AI model based on the first parameter updates;
determining second parameter updates for the updated AI model by performing a pair-wise adaptation process based on adjusting embedding representations of a pair of input samples based on a threshold to correspond to a same identity; and
generating a final adapted AI model based on the second parameter updates, wherein the final adapted AI model is adapted to the target domain.
